(19) United States
(12) Patent Application Publication
(10) Pub. No.: US 2023/0350726 A1
(43) Pub. Date: Nov. 2, 2023

(54) OBJECT STORAGE CACHE PREWARMING

(71) Applicant: NetApp, Inc., San Jose, CA (US)

(72) Inventors: Morgan Mears, Raleigh, NC (US); Samuel Quincy Fink, Cary, NC (US)

(21) Appl. No.: 17/660,900

(22) Filed: Apr. 27, 2022

(51) Int. Cl. G06F 9/50

(52) U.S. Cl. CPC G06F 9/505

(57) ABSTRACT

One or more systems, devices, computer program products, and/or computer-implemented methods of use provided herein to a readahead process related to an object at an object storage system. A system can comprise a memory that stores computer executable components, and a processor that executes the computer executable components stored in the memory, wherein the computer executable components can comprise a detection component that, based on data from a load balancer of an object storage system, determines a trigger to perform a readahead of an object at the object storage system prior to receipt of a request related to the object, and a readahead component that, based on the trigger, executes the readahead of the object. The detection component can determine a pattern of use of the object storage system. The detection component can comprise or access a machine learning model to perform the determination.

### TECHNICAL FIELD

The subject disclosure relates generally to object storage systems, and more specifically to facilitating machine learning classification of object storage system workloads, access, and/or uses.

### BACKGROUND

An object storage system (e.g., an object-oriented database, such as a cloud storage platform) can electronically record computerized objects for a client device (e.g., a client laptop computer, a client desktop computer, a client smart phone, and/or the like). The volume and/or characteristics of computerized objects (referred to herein simply as “objects”) can be recorded in the object storage system on behalf of a client device. Object-storage operations (e.g., GET operations, HEAD operations, DELETE operations, READ operations, and/or the like) which the client device requests to be performed on such computerized objects, can be considered as an object store workload associated with the client device, such as relative to data of an object, which data can comprise metadata.

### SUMMARY

The following presents a summary to provide a basic understanding of one or more embodiments described herein. This summary is not intended to identify key or critical elements, delineate scope of particular embodiments or scope of claims. Its sole purpose is to present concepts in a simplified form as a prelude to the more detailed description that is presented later. In one or more embodiments described herein, systems, computer-implemented methods, apparatuses, and/or computer program products can facilitate a readahead operation related to an object at an object storage system.

In accordance with an embodiment, a system can comprise a memory that stores computer executable components, and a processor that executes the computer executable components stored in the memory, wherein the computer executable components can comprise a detection component that, based on data from a load balancer of an object storage system, determines a trigger to perform a readahead of an object at the object storage system prior to receipt of a request related to the object, and a readahead component that, based on the trigger, executes the readahead of the object.

In accordance with another embodiment, a computer-implemented method can comprise determining, by a system operatively coupled to a processor, based on data from a load balancer of an object storage system, a trigger to perform a readahead of an object at the object storage system prior to receipt of a request related to the object, and executing, by the system, based on the trigger, the readahead of the object.

In accordance with yet another embodiment, a computer program product facilitating a readahead process related to an object at an object storage system, the program instructions executable by a processor to cause the processor to determine, by the processor, based on data from a load balancer of an object storage system, determines a trigger to perform readahead of an object at the object storage system prior to receipt of a request related to the object, and execute, by the processor, based on the trigger, the readahead of the object.

An advantage of the aforementioned systems, devices, computer program products, and/or computer-implemented methods can be an ability to reduce time and/or computing power involved with data reading and/or retrieval, such as relative to an object of an object storage system.

Another advantage of the aforementioned systems, devices, computer program products, and/or computer-implemented methods can be an ability to pre-empt one or more instructions, such as get and/or read instructions, which thus need not be sent.

Another advantage of the aforementioned systems, devices, computer program products, and/or computer-implemented methods can be an ability to learn and respond to new patterns and/or changes in patterns of use of an associated object storage system. This can be in relation to use of particular quantities or portions of data and/or in relation to one or more data groupings (e.g., objects) such as across plural nodes of an associated object storage system.

### DESCRIPTION OF THE DRAWINGS

FIG. 1 illustrates a block diagram of an example, non-limiting object storage system that can facilitate pattern-enhanced readahead operations, in accordance with one or more embodiments described herein.

FIG. 2 illustrates a block diagram of another example, non-limiting object storage system that can facilitate pattern-enhanced readahead operations, in accordance with one or more embodiments described herein.

FIG. 3 illustrates a block diagram of an example, non-limiting system that can facilitate pattern-enhanced readahead operations in conjunction with an object storage system, in accordance with one or more embodiments described herein.

FIG. 4 illustrates a block diagram of another example, non-limiting system that can facilitate pattern-enhanced readahead operations in conjunction with an object storage system, in accordance with one or more embodiments described herein.

FIG. 5 depicts a block-based flow diagram of a process to implement a readahead operation, in accordance with one or more embodiments described herein.

FIG. 6 illustrates a process flow for facilitating a readahead process related to an object at an object storage system, in accordance with one or more embodiments described herein.

FIG. 7 depicts a block-based flow diagram of a process to train a machine learning model employed in implementing a readahead operation, in accordance with one or more embodiments described herein.

FIG. 8 illustrates another process flow for facilitating a readahead process related to an object at an object storage system, in accordance with one or more embodiments described herein.

FIG. 9 illustrates a block diagram of an example, non-limiting, operating environment in which one or more embodiments described herein can be facilitated.

FIG. 10 illustrates a block diagram of an example, non-limiting, cloud computing environment in accordance with one or more embodiments described herein.

### DETAILED DESCRIPTION

The following detailed description is merely illustrative and is not intended to limit embodiments and/or application or utilization of embodiments. Furthermore, there is no intention to be bound by any expressed or implied information presented in the preceding Summary section, or in the Detailed Description section. One or more embodiments are now described with reference to the drawings, wherein like reference numerals are utilized to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Relative to use of an object storage system, generally, it can be desirable to reduce cost of one or more operations associated with an object storage system. As used herein, cost can refer to time, money, power, storage, memory, bandwidth, labor and/or the like. For example, one or more clients can repeatedly, over time, request the same GET/READ operations back-to-back. In another example, one or more clients can request performance of one or more operations at a same frequency. In yet another example, one or more clients can request one or more operations after the occurrence of the same or like events.

Generally, a framework is described herein that can comprise generating information regarding patterns of use of an object storage system. The patterns can be employed to detect usage of the object storage system following, commensurate with and/or similar to one or more patterns of use. Detection can trigger one or more readahead operations that can reduce the cost to the object storage system and/or to the client. That is, one or more readahead operations can be performed relative to an object prior to receipt of a request related to the object.

As used herein both above and below, “a readahead of an object” can refer to reading an amount of data/metadata/blocks of a file/volume/object to have the data/metadata/blocks available in memory, such as fast memory or short-term memory. That is, as used herein both above and below, “a readahead of an object” can refer to a readahead of a whole or only part of an object, and thus of at least part of an object, such as some data of the object.

As used herein both above and below, “data” can comprise metadata.

As used herein both above and below, “use” can comprise access.

As used herein both above and below, “client” can refer to a device, network, application, virtual machine, system, machine, component, hardware, software, smart device, and/or human.

As used herein both above and below, “entity” can refer to a device, network, application, virtual machine, system, machine, component, hardware, software, smart device, and/or human.

In one or more cases, an analytical model can be employed, to some degree, to analyze use data of the object storage system, such as from one or more nodes and/or from a load balancer associated with the one or more nodes. One or more patterns of use of the object storage system can be learned, recorded, logged and/or otherwise observed. The observation can be performed individually relative to particular nodes and/or relative to a load balancer associated with plural nodes.

Analytical models, such as neural networks, have produced state-of-the-art and human-like performance across a variety of tasks. As used herein, analytical models can be, be comprised by and/or comprise predictive models, neural networks, deep learning (DL) models, machine learning (ML) models, artificial intelligence (AI) models and/or the like.

By learning and detecting patterns of use of an object storage system, such as from data from one or more nodes and/or from a load balancer associated with the one or more nodes, time to complete operations that require read instructions can be reduced. Memory allocation can be better scheduled. Further, operations can be performed faster without waiting on responses to one or more requests to the object storage system, and in one or more cases, without a need to even employ, generate and/or execute one or more of the one or more requests. This is at least because a readahead (also herein referred to as a readahead operation or readahead process) is triggered and then performed based on the learned and detected patterns.

In the following description, for purposes of explanation, numerous specific details are set forth in order to provide a more thorough understanding of the one or more embodiments. It is evident, however, in various cases, that the one or more embodiments can be practiced without these specific details.

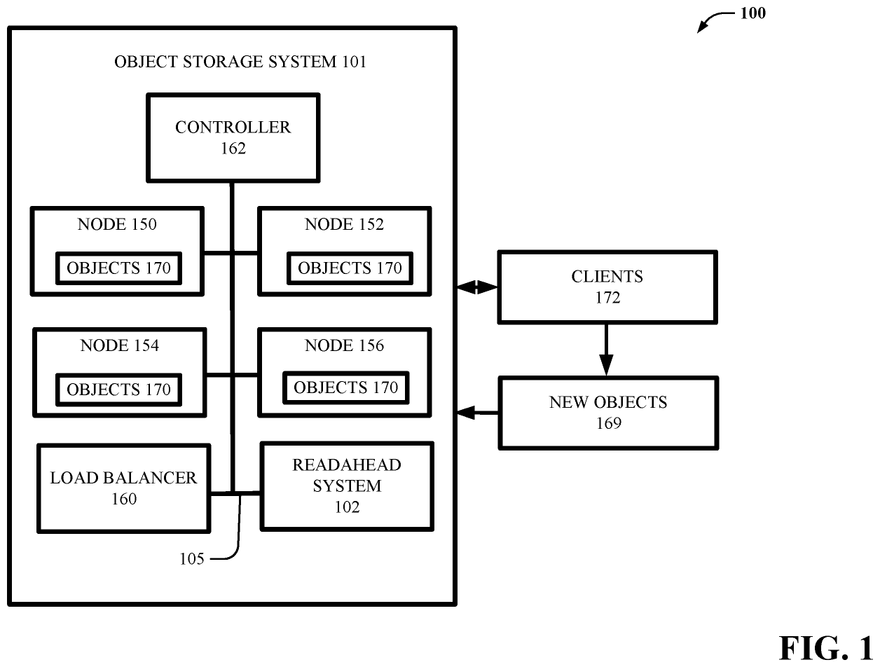

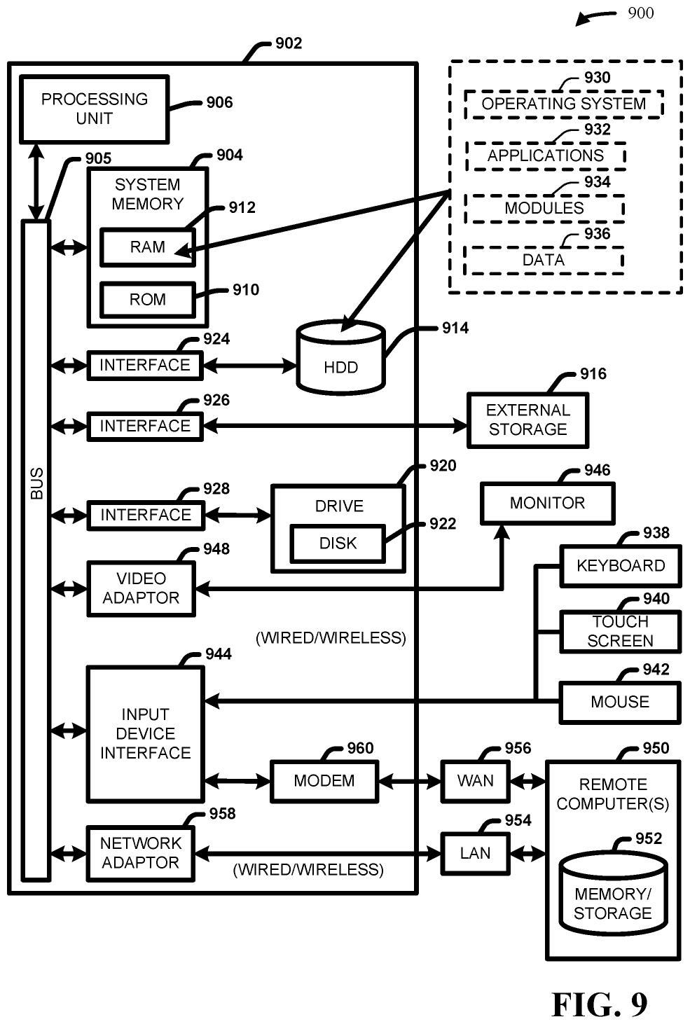

Further, the embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting systems 10, 200, 300, and/or 400 as illustrated at FIGS. 1 to 4, and/or systems thereof, can further comprise, be associated with and/or be coupled to one or more computer and/or computing-based elements described herein with reference to an operating environment, such as the cloud operating environment 900 illustrated at FIG. 9. In one or more described embodiments, computer and/or computing-based elements can be used in connection with implementing one or more of the systems, devices, components and/or computer-implemented operations shown and/or described in connection with FIGS. 1, 2, 3, and/or 4, and/or with other figures described herein.

Turning first generally to FIG. 1, one or more embodiments of the non-limiting system 100 described herein can include one or more devices, systems and/or apparatuses that can facilitate a readahead process related to an object at an object storage system, in accordance with one or more embodiments described herein. While referring here to one or more processes, facilitations and/or uses of the non-limiting system 100, description provided herein, both above and below, also can be relevant to one or more other non-limiting systems described herein, such as the non-limiting systems 200, 300, and/or 400, to be described below in detail.

The non-limiting system 100 can facilitate both a readahead process related to an object at an object storage system, and a process to store and facilitate use of objects, which can be physically stored separate from a client local system. As illustrated, the non-limiting system 100 can comprise an object storage system 101 having a plurality of nodes 150, 152, 154, 156 (e.g., 150-156). The nodes 150-156 can store objects 170, such as data, software elements, applications elements and/or the like. In one or more embodiments, a controller 162 can facilitate the execution of this storage of the objects 170 and of new objects 169, and subsequent recall or reading of data of the objects. In one or more embodiments, the object storage system 101 (e.g., the controller 162 or load balancer 160) can be configured to move one or more objects 170 over plural nodes of the object storage system over a life of the one or more objects at the object storage system.

A load balancer 160 can direct storage, use, read, access and/or other traffic to and from the nodes 150-156, such as in a manner that distributes workload, memory use and/or the like. In this way, use of the object storage system 101 by one or more clients 172 can be executed with greater speed.

A bus 105 can facilitate local communication between the elements of the object storage system 101.

In one or more embodiments, the object storage system 101 can comprise a readahead system 102. Generally, such readahead system 102 can facilitate execution of a readahead of one or more objects 170 of the object storage system 101, such as prior to receipt of a request related to the objects 170, such as from one or more clients 172. The readahead can be of all or a portion of data of the object 170.

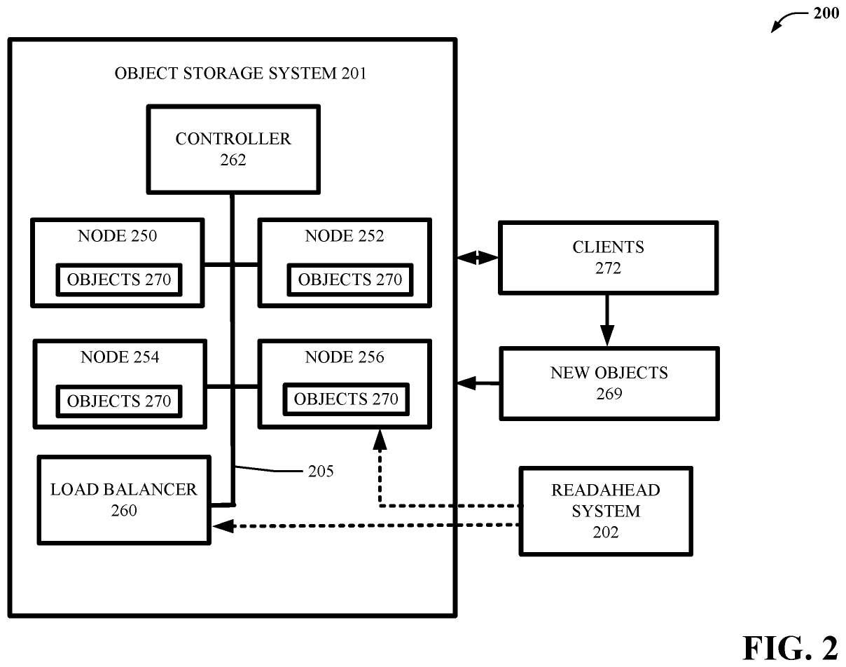

Turning next to FIG. 2, another non-limiting system 200 is illustrated. One or more embodiments of the non-limiting system 200 described herein can include one or more devices, systems and/or apparatuses that can facilitate a readahead process related to an object at an object storage system, in accordance with one or more embodiments described herein. Repetitive description of like elements and/or processes employed in respective embodiments is omitted for the sake of brevity. While referring here to one or more processes, facilitations and/or uses of the non-limiting system 200, description provided herein, both above and below, also can be relevant to one or more other non-limiting systems described herein, such as the non-limiting systems 100, 300, and/or 400, to be described below in detail.

Like the non-limiting system 100, the non-limiting system 200 that can facilitate both a readahead process related to an object at an object storage system, and a process to store and facilitate use of objects, which can be physically stored separate from a client local system. As illustrated, the non-limiting system 200 can comprise an object storage system 201 having a plurality of nodes 250, 252, 254, 256 (e.g., 250-256). The nodes 250-256 can store objects 270, such as data, software elements, applications elements, and/or the like. In one or more embodiments, a controller 262 can facilitate the execution of this storage of the objects 270 and of new objects 269, and subsequent recall or reading of data of the objects. A load balancer 260 can direct storage, use, read, access, and/or other traffic to and from the nodes 250-256, such as in a manner that distributes workload, memory use, and/or the like. In this way, use of the object storage system 201 by one or more clients 272 can be executed with greater speed.

A bus 205 can facilitate local communication between the elements of the object storage system 201.

In one or more embodiments, the non-limiting system 200 can comprise a readahead system 202. The object storage system 201 and readahead system 202 are separate from one another, and thus the readahead system 202 can be external to the object storage system 201. As illustrated, the readahead system 202 can communicate either directly with one or more of the nodes 250-256 or with the load balancer 260. Generally, the readahead system 202 can facilitate execution of readahead of one or more objects 270 of the object storage system 201, such as prior to receipt of a request related to the objects 270, such as from one or more clients 272. The readahead can be of all or a portion of data of an object 270.

Communication between the readahead system 202 and the object storage system 201 can be facilitated by wired and/or wireless means including, but not limited to, employing a cellular network, a wide area network (WAN) (e.g., the Internet), and/or a local area network (LAN). Suitable wired or wireless technologies for facilitating the communications can include, without being limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), high speed packet access (HSPA), Zigbee and other 802.XX wireless technologies, and/or legacy telecommunication technologies, BLUETOOTH®, Session Initiation Protocol (SIP), ZIGBEE®, RF4CE protocol, WirelessHART protocol, 6LoWPAN (Ipv6 over Low power Wireless Area Networks), Z-Wave, an ANT, an ultra-wideband (UWB) standard protocol, and/or other proprietary, and/or non-proprietary communication protocols.

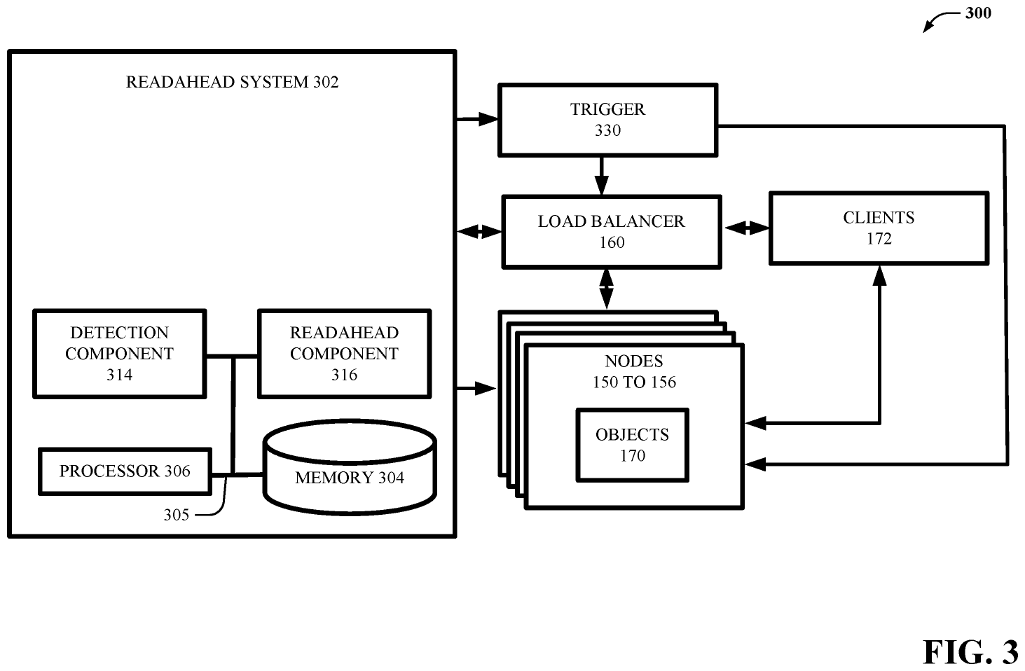

Referring next to FIG. 3, a non-limiting system 300 is depicted. One or more embodiments of the non-limiting system 300 described herein can include one or more devices, systems, and/or apparatuses that can facilitate a readahead process related to an object at an object storage system, in accordance with one or more embodiments described herein. Repetitive description of like elements and/or processes employed in respective embodiments is omitted for the sake of brevity. While referring here to one or more processes, facilitations, and/or uses of the non-limiting system 300, description provided herein, both above and below, also can be relevant to one or more non-limiting systems or elements of other non-limiting systems described herein, such as the non-limiting system 400, to be described below in detail, the readahead system 102 and/or the readahead system 202.

The non-limiting system 300 can comprise a readahead system 302 that can facilitate a readahead process related to an object at an object storage system. As illustrated the readahead system 302 can comprise a detection component 314, readahead component 316, processor 306, memory 304, and/or bus 305. Generally, the readahead system 302 can facilitate a readahead process relative to an object via one or more communications with a load balancer or one or more nodes of an object storage system, such as relative to an object 170 via one or more communications with a load balancer 160 or one or more nodes 150 to 156. Accordingly, when a client 172 requests data of an object, in one or more cases, such data can already have been read and can quickly and efficiently be provided to the client 172, such as by the load balancer 160 and/or by one or more of the nodes 150-156.

That is, generally, the detection component 314 can, based on data from one or more of the nodes 150-156 directly, or from one or more of the nodes 150-156 via the load balancer 160, determine a trigger 330 to perform a readahead of an object 170 at the respective object storage system prior to receipt of a request related to the object 170, such as from a client 172. In response to the trigger 330, the readahead component 316 can execute a readahead, also referred to herein as a readahead operation or readahead process, of the object 170. The readahead can be of all or a portion of data of the object 170.

The detection component 314, and thus the readahead system 302, can generally access the object 170 by employing any suitable method of communication, by wired and/or wireless means including, but not limited to, employing a cellular network, a wide area network (WAN) (e.g., the Internet), and/or a local area network (LAN). Suitable wired or wireless technologies for facilitating the communications can include, without being limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), high speed packet access (HSPA), Zigbee and other 802.XX wireless technologies, and/or legacy telecommunication technologies, BLUETOOTH®, Session Initiation Protocol (SIP), ZIGBEE®, RF4CE protocol, WirelessHART protocol, 6LoWPAN (Ipv6 over Low power Wireless Area Networks), Z-Wave, an ANT, an ultra-wideband (UWB) standard protocol, and/or other proprietary, and/or non-proprietary communication protocols.

One or more aspects of a component (e.g., the detection component 314 or readahead component 316) can be employed separately and/or in combination, such as employing one or more of the memory 304 or the processor 306. Additionally, and/or alternatively, the processor 306 can execute one or more program instructions to cause the processor 306 to perform one or more operations by these components.

It is noted that in one or more embodiments, the readahead system 302 can be separate from, and thus external to, a respective object storage system having the load balancer 160 and nodes 150-156. In one or more other embodiments, the readahead system 302 can be comprised by, and thus internal to, a respective object storage system having the load balancer 160 and nodes 150-156.

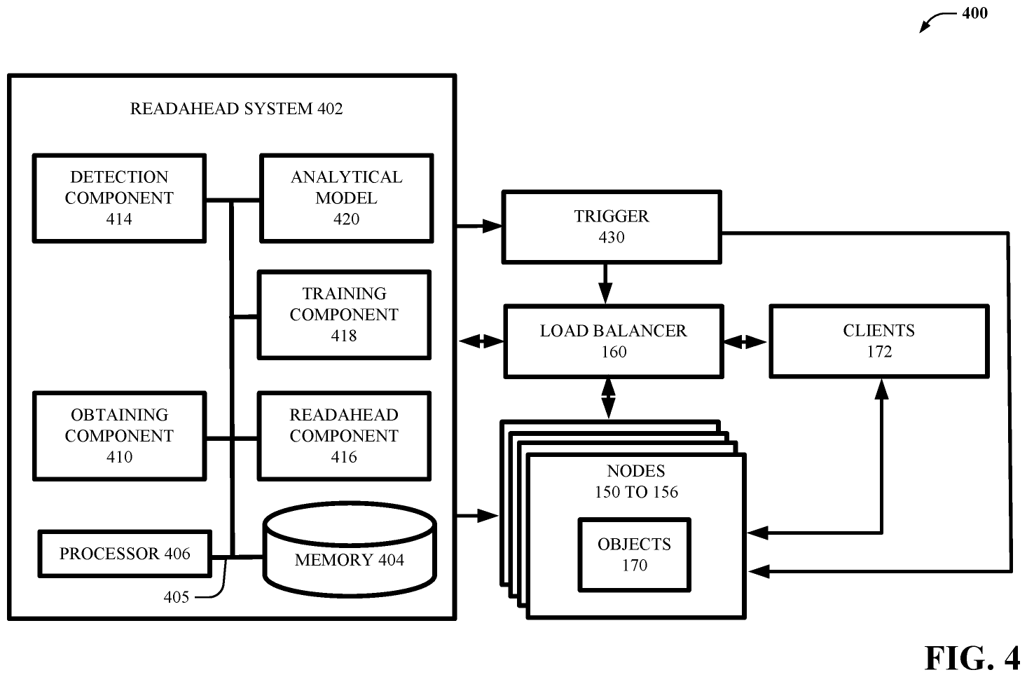

Turning next to FIG. 4, a non-limiting system 400 is depicted. One or more embodiments of the non-limiting system 400 described herein can include one or more devices, systems, and/or apparatuses that can facilitate a readahead process related to an object at an object storage system, in accordance with one or more embodiments described herein. Repetitive description of like elements and/or processes employed in respective embodiments is omitted for the sake of brevity. While referring here to one or more processes, facilitations, and/or uses of the non-limiting system 400, description provided herein, both above and below, also can be relevant to one or more non-limiting systems or elements of other non-limiting systems described herein, such as the non-limiting system 300, the readahead system 102 and/or the readahead system 202.

The non-limiting system 400 can comprise a readahead system 402 that can facilitate a readahead process related to an object at an object storage system. Generally, the readahead system 402 can facilitate a readahead process relative to an object via one or more communications with a load balancer or one or more nodes of an object storage system, such as relative to an object 170 via one or more communications with a load balancer 160 or one or more nodes 150 to 156. Accordingly, when a client 172 requests data of an object, in one or more cases, such data can already have been read and can quickly and efficiently be provided to the client 172, such as by the load balancer 160 and/or by one or more of the nodes 150-156.

The readahead system 402, as illustrated, can comprise any suitable type of component, machine, device, facility, apparatus, and/or instrument that comprises a processor and/or can be capable of effective and/or operative communication with a wired and/or wireless network. All such embodiments are envisioned. For example, the readahead system 402 can comprise a server device, computing device, general-purpose computer, special-purpose computer, tablet computing device, handheld device, server class computing machine and/or database, laptop computer, notebook computer, desktop computer, cell phone, smart phone, consumer appliance, and/or instrumentation, industrial and/or commercial device, digital assistant, multimedia Internet enabled phone, multimedia players and/or another type of device and/or computing device. Likewise, the readahead system 402 can be disposed and/or run at any suitable device, such as, but not limited to a server device, computing device, general-purpose computer, special-purpose computer, tablet computing device, handheld device, server class computing machine and/or database, laptop computer, notebook computer, desktop computer, cell phone, smart phone, consumer appliance, and/or instrumentation, industrial and/or commercial device, digital assistant, multimedia Internet enabled phone, multimedia players, and/or another type of device, and/or computing device.

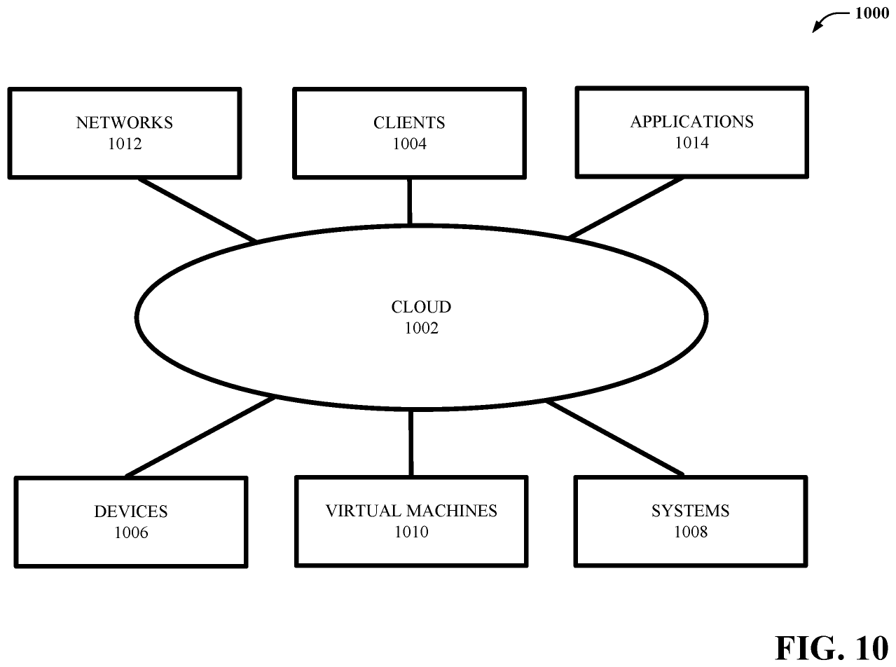

The readahead system 402 can be associated with, such as accessible via, a cloud computing environment. For example, the readahead system 402 can be associated with a cloud computing environment 1002 described below with reference to illustration 1000 of FIG. 10.

Operation of the non-limiting system 400 and/or of the readahead system 402 is not limited to performance of a single readahead operation, generation of a single pattern, observation of a single pattern of use, and/or generation of a single trigger. Rather, operation of the non-limiting system 400 and/or of the readahead system 402 can be scalable. For example, the non-limiting system 200 and/or the readahead system 402 can facilitate plural action performances of one or more types at least partially in parallel with one another.

As illustrated the readahead system 402 can comprise a detection component 414, readahead component 416, obtaining component 410, training component 418, analytical model 420, processor 406, memory 404, and/or bus 405. Generally, the detection component 414 can, based on data from one or more of the nodes 150-156 directly, or from one or more of the nodes 150-156 via the load balancer 160, determine a trigger 430 to perform a readahead of an object 170 at the respective object storage system prior to receipt of a request related to the object 170, such as from a client 172. In response to the trigger 430, the readahead component 416 can execute a readahead, also referred to herein as a readahead operation, of the object 170. The readahead can be of all or a portion of data of the object 170.

One or more communications between one or more components of the non-limiting system 400 and/or readahead system 402 can be facilitated by wired and/or wireless means including, but not limited to, employing a cellular network, a wide area network (WAN) (e.g., the Internet), and/or a local area network (LAN). Suitable wired or wireless technologies for facilitating the communications can include, without being limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), high speed packet access (HSPA), Zigbee and other 802.XX wireless technologies, and/or legacy telecommunication technologies, BLUETOOTH®, Session Initiation Protocol (SIP), ZIGBEE®, RF4CE protocol, WirelessHART protocol, 6LoWPAN (Ipv6 over Low power Wireless Area Networks), Z-Wave, an ANT, an ultra-wideband (UWB) standard protocol, and/or other proprietary and/or non-proprietary communication protocols.

Discussion now turns to the processor 406, memory 404, and bus 405 of the readahead system 402.

For example, in one or more embodiments, readahead system 402 can comprise a processor 406 (e.g., computer processing unit, microprocessor, classical processor, and/or like processor). In one or more embodiments, a component associated with readahead system 402, as described herein with or without reference to the one or more figures of the one or more embodiments, can comprise one or more computer and/or machine readable, writable and/or executable components and/or instructions that can be executed by processor 406 to facilitate performance of one or more processes defined by such component(s) and/or instruction(s). In one or more embodiments, the processor 406 can comprise detection component 414, readahead component 416, obtaining component 410, training component 418, and/or analytical model 420.

In one or more embodiments, the readahead system 402 can comprise a computer-readable memory 404 that can be operably connected to the processor 406. The memory 404 can store computer-executable instructions that, upon execution by the processor 406, can cause the processor 406 and/or one or more other components of the readahead system 402 (e.g., detection component 414, readahead component 416, obtaining component 410, training component 418, and/or analytical model 420) to perform one or more actions. In one or more embodiments, the memory 404 can store computer-executable components (e.g., detection component 414, readahead component 416, obtaining component 410, training component 418, and/or analytical model 420).

Readahead system 402 and/or a component thereof as described herein, can be communicatively, electrically, operatively, optically, and/or otherwise coupled to one another via a bus 405 to perform functions of non-limiting system 400, readahead system 402 and/or one or more components thereof and/or coupled therewith. Bus 405 can comprise one or more of a memory bus, memory controller, peripheral bus, external bus, local bus, and/or another type of bus that can employ one or more bus architectures. One or more of these examples of bus 405 can be employed to implement one or more embodiments described herein.

In one or more embodiments, the readahead system 402 can be coupled (e.g., communicatively, electrically, operatively, optically, and/or like function) to one or more external systems (e.g., a non-illustrated electrical output production system, one or more output targets, an output target controller, and/or the like), sources and/or devices (e.g., computing devices, communication devices, and/or like devices), such as via a network. In one or more embodiments, one or more of the components of the readahead system 402 can reside in the cloud and/or can reside locally in a local computing environment (e.g., at a specified location(s)).

In addition to the processor 406 and/or memory 404 described above, the readahead system 402 can comprise one or more computer and/or machine readable, writable, and/or executable components and/or instructions that, when executed by processor 406, can facilitate performance of one or more operations defined by such component(s) and/or instruction(s).

Turning now first to the obtaining component 410, the obtaining component 410 can locate, find, search, and/or otherwise obtain use data of use of an object storage system from a respective load balancer (e.g., load balancer 160) relative to one or more nodes (e.g., nodes 150 to 156). The obtaining component 410 can locate, find, search, and/or otherwise obtain use data of use of an object storage system directly from the one or more nodes (e.g., nodes 150 to 156).

The obtaining can comprise observation of access and/or use data of a client 172. The use data can comprise context such as type of client, frequency of use/access, order of use/access, one or more uses/accesses that occur together and/or in a particular order, one or more events that occur before/during/prior to one or more uses/access, and/or a combination thereof.

For example, access to one node can be a precursor to access to another node; access to one object can be a precursor to access to another object; and/or access to an object can be a precursor to access to a node, or vice versa. A pattern can additionally and/or alternatively be based on use of same bucket names but differing extensions, on an order of instructions requested and/or performed, and/or on a frequency of instructions requested and/or performed.

For example, one or more clients can repeatedly, over time, request same GET/READ operations back-to-back. In another example, one or more clients can request performance of one or more operations at a same frequency. In yet another example, one or more clients can request one or more operations after occurrence of same or like events. In another example, a LIST request can be a predictor that GET requests will subsequently follow the LIST request, such as GET requests in an order returned from the LIST request. In another example, a LIST request that follows a GET request can be a predictor that additional GET requests will subsequently follow the LIST request, such as GET requests in an order returned from the LIST request.

The use data can comprise any suitable piece and/or collection of electronic data that conveys and/or otherwise indicates how various electronic and/or computerized resources (e.g., processors, hard disk drives (HDDs), solid state drives (SSDs), random access memories (RAMs), and/or network communication channels) of the object storage system are being used, operated, and/or consumed. For example, in various aspects, the use data can comprise one or more scalars, vectors, matrices, tensors, character strings, and/or any suitable combination thereof that indicate, and/or convey one or more CPU utilizations of the object storage system (e.g., a CPU utilization can be a ratio between an amount of work, and/or computing that is actually being performed by a processor to a maximum amount of work, and/or computing that could be performed by the processor). As another example, the use data can include one or more scalars, vectors, matrices, tensors, character strings, and/or any suitable combination thereof that indicate and/or convey one or more disk utilizations of the object storage system (e.g., a disk utilization can be a ratio between an amount of memory space that is actually consumed in an HDD and/or SSD to a maximum amount of memory space that could be consumed in that HDD and/or SSD). As still another example, the use data can comprise one or more scalars, vectors, matrices, tensors, character strings, and/or any suitable combination thereof that indicate and/or convey one or more memory utilizations of the object storage system (e.g., a memory utilization can be a ratio between an amount of memory space that is actually consumed by a RAM to a maximum amount of memory space that could be consumed by that RAM). As yet another example, the use data can comprise one or more scalars, vectors, matrices, tensors, character strings, and/or any suitable combination thereof that indicate and/or convey one or more network bandwidth utilizations of the object storage system (e.g., a network bandwidth utilization can be a ratio between an amount of traffic and/or bandwidth that is actually consumed in a network communication channel to a maximum amount of traffic and/or bandwidth that could be consumed in that network communication channel).

Various sets of use data from various instances of observation and/or from observation of different elements of an object storage system can be written, logged, stored, and/or the like, such as at memory 404 and/or any other storage external and/or internal to the readahead system 402.

Based on the data (e.g., use data, which can comprise access data) from the object storage system (e.g., from a load balancer), the detection component 414 can generate one or more patterns of known use of the respective object storage system.

More particularly, the detection component can comprise and/or employ an analytical model 420 to analyze the use data and to generate one or more patterns.

In the field of analytical modeling, analytical models can be employed to provide analysis, prediction, estimation, statistics and/or the like. Such analytical models can be, comprise and/or be comprised by classical models, such as predictive models, neural networks, and/or artificial intelligent models. Artificial intelligent models and/or neural networks (e.g., a convolutional network and/or deep neural network) can comprise and/or employ artificial intelligence (AI), machine learning (ML), and/or deep learning (DL), where the learning can be supervised, semi-supervised and/or unsupervised.

Generally, such analytical models can be trained on a set of training data that can represent the type of data for which the system will be used. Different analytical models can have different accuracies relative to data that is output by the analytical model. Such accuracy can be quantized as compared to ideal and/or known results of a training set of data.

That is, the analytical model 420 can, based on behavior of one or more clients 172, facilitate not only generation of a single set of patterns for use in observing actual/present/current use of the respective object storage system, but also can continually learn and thus can generate one or more new patterns based on new observations, new uses, new accesses and/or the like relative to the respective object storage system. Put another way, the detection component 414 can determine a detection (or of a trigger 430) based on a use of the object storage system that corresponds to a known pattern of use or that corresponds to another pattern of use, such as one based at least in part on a known pattern of use. It is noted that such training data can be cross-node (e.g., based on combination of use/access to plural nodes).

The detection component 414 can be configured, such as by a client 172 and/or other administrating entity, to observe current/present/real-time use and/or access of the object storage system at any suitable frequency. For example, based on the observation, the detection component 414 and/or analytical model 420 can recognize occurrence of or predict occurrence of a known, similar or new pattern occurring. Based on the recognition and/or prediction, the detection component 414 can generate a trigger 430. The trigger 430 can be any suitable message, communication, notification, alarm, signal, and/or the like, such as to the readahead component 416 and/or processor 406. It is noted that such observations can be cross-node (e.g., based on combination of use/access to plural nodes).

Based on the trigger 530 (e.g., based on detection of, observation of, access to, receiving, obtaining and/or otherwise determining the trigger 530), the readahead component 416 can execute one or more readahead operations of one or more quantities of data of one or more objects 170 at a respective object storage system. The readahead operation can be performed at one node and/or across plural nodes. The readahead operation can comprise a read of a portion or more of one or more objects at one or more nodes of a respective object storage system. An output of the readahead operation can be associated with an output operation which can comprise storage (e.g., temporary storage) of data and/or communication of data to a client (e.g., client 172).

That is, put simply, prior to receipt of a request related to an object (e.g., a request to read a portion or more of the object), the readahead operation can be pre-executed, with the data being made ready for use by the client 172. This can speed up one or more operations of the client 172, thus increasing client satisfaction.

In one or more embodiments, the readahead operation can be tabled (e.g., scheduled for a later time) based on the learned use/access/behavior via the detection component 414. The scheduling can be executed by the readahead component 416 and/or by the processor 406.

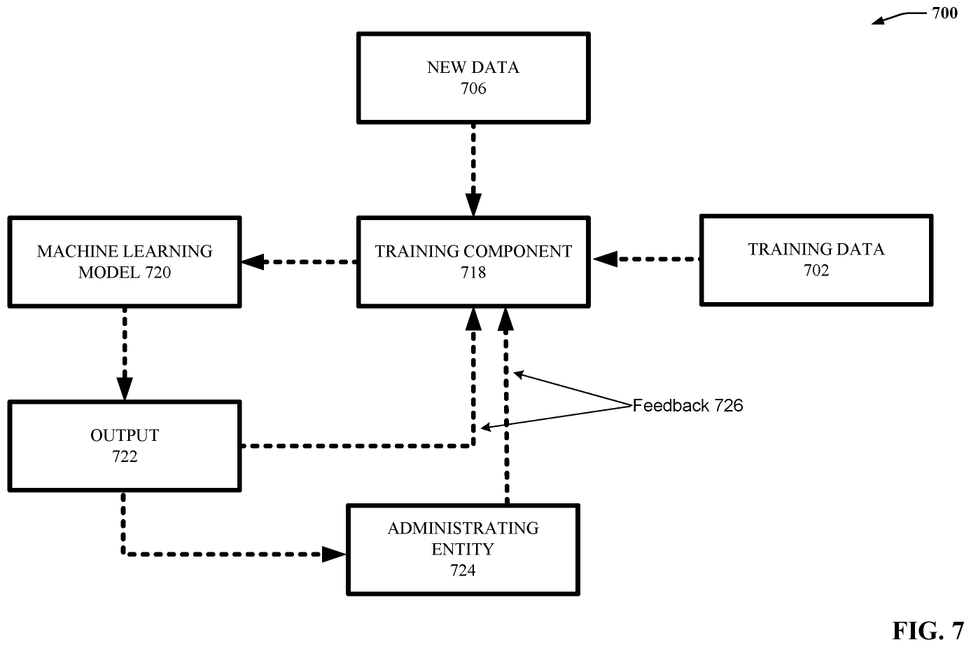

Referring still to FIG. 4, in one or more embodiments, the readahead system 402 can comprise a training component 418. The training component 418 can train the detection component 414 and/or the analytical model 420 based on various data/access/use/behavior associated with the respective object storage system, such as based on historical data defining access behavior to the object storage system from the load balancer and/or nodes. In one or more cases, the historical data can comprise data from plural nodes of the object storage system. Further information regarding such training is described below, relative to FIG. 7, which can be applicable to FIG. 4.

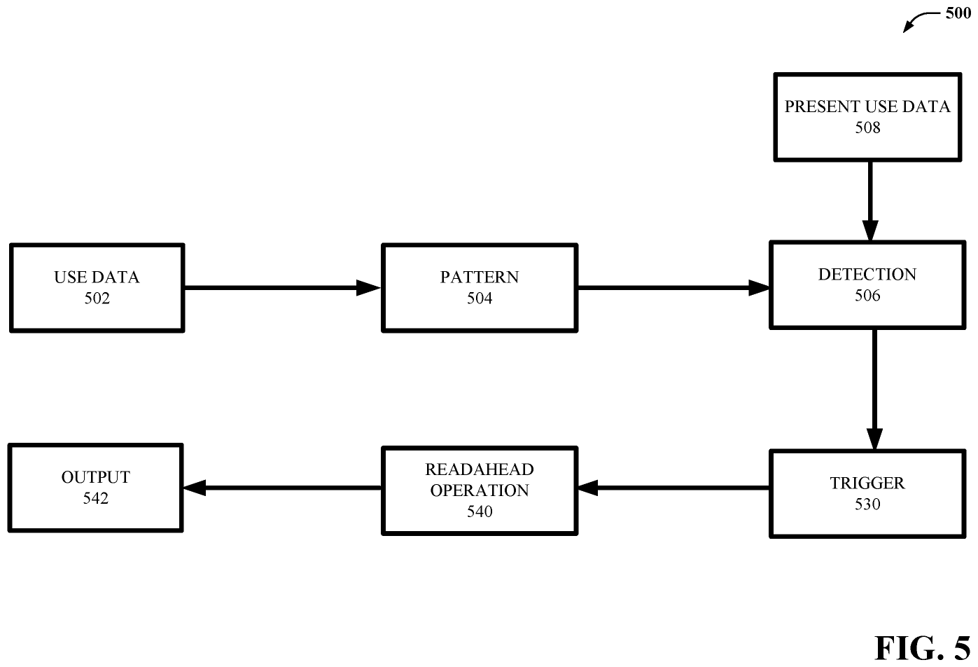

Turning now to FIG. 5, the figure illustrates a diagram of an example, non-limiting flow chart 500 that can facilitate a readahead process related to an object at an object storage system, in accordance with one or more embodiments described herein. While the non-limiting flow chart 500 is described relative to the non-limiting system 400 of FIG. 4, the non-limiting flow chart 500 can be applicable also to other systems described herein, such as the non-limiting system 300 of FIG. 3. Repetitive description of like elements and/or processes employed in respective embodiments is omitted for the sake of brevity.

That is, relative to various components described at the readahead system 402 of FIG. 4, use data 502 can be obtained (e.g., by the obtaining component 410) from one or more nodes directly and/or from a respective load balancer (e.g., load balancer component). The use data 502 can be employed (e.g., by the detection component 414 and/or analytical model 420) to generate one or more patterns 504. The one or more patterns 504 can be employed (e.g., by the detection component 414) to generate one or more detections 506 of use of an object storage system, such as based on one or more observations (e.g., by the detection component 414) of present use data 508. The detection 506 can thus trigger generation of a trigger 530 (e.g., by the detection component 414), thus notifying the readahead system (e.g., readahead system 402) and a respective readahead component (e.g., readahead component 416) that a readahead operation 540 can be executed. The readahead operation 540 can be executed (e.g., by the readahead component 416). In response to execution of the readahead operation 540, one or more outputs 542 can be generated. An output 542 can comprise a read of a portion or more of one or more objects at one or more nodes of a respective object storage system. The output 542 can be associated with an output operation which can comprise storage (e.g., temporary storage) of data and/or communication of data to a client (e.g., client 172).

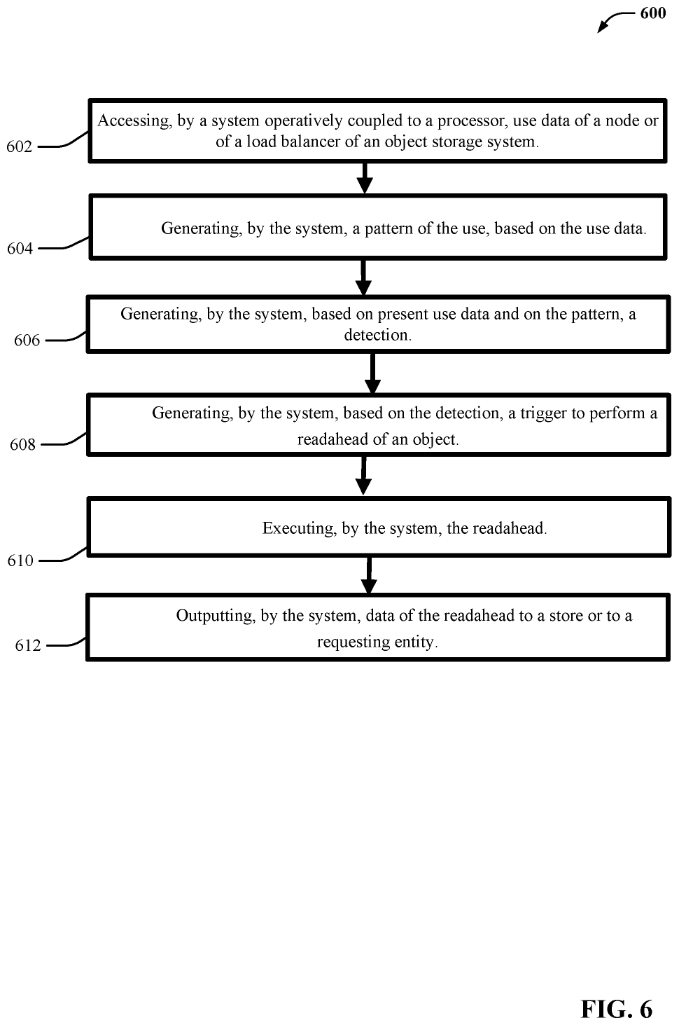

Next, FIG. 6 illustrates a flow diagram of an example, non-limiting method 600 that can facilitate a readahead process related to an object at an object storage system, in accordance with one or more embodiments described herein, such as the non-limiting 400 of FIG. 4 and the non-limiting flow chart 500 of FIG. 5. While the non-limiting method 600 is described relative to the non-limiting system 400 of FIG. 4 and the non-limiting flow chart 500 of FIG. 5, the non-limiting method 600 can be applicable also to other systems described herein, such as the non-limiting system 300 of FIG. 3. Repetitive description of like elements and/or processes employed in respective embodiments is omitted for the sake of brevity.

At 602, the non-limiting method 600 can comprise accessing, by a system operatively coupled to the processor (e.g., obtaining component 410), use data (e.g., use data 502) of a node or of a load balancer of an object storage system.

At 604, the non-limiting method 600 can comprise generating, by the system (e.g., detection component 414) a pattern (e.g., pattern 504) of the use, based on the use data (502).

At 606, the non-limiting method 600 can comprise generating, by the system (e.g., detection component 414), based on present use data and on the pattern, a detection (e.g., detection 506).

At 608, the non-limiting method 600 can comprise generating, by the system (e.g., detection component 414), based on the detection, a trigger (e.g., trigger 630) to perform a readahead of an object.

At 610, the non-limiting method 600 can comprise executing, by the system (e.g., readahead component 416), the readahead (e.g., readahead 540).

At 612, the non-limiting method 600 can comprise outputting, by the system (e.g., readahead component 416), data (e.g., output 542) of the readahead to a store or to a requesting entity (e.g., client 172).

Turning now to FIG. 7, illustrated is the figure illustrates a diagram of an example, non-limiting training sub-system 700 that can facilitate a process for training a detection component (e.g., detection component 414), analytical model (e.g., analytical model 420) and/or the like. That is, while the non-limiting training sub-system 700 depicts a machine learning (ML) model 720, in one or more embodiments the ML model 720 can be replaced by a detection component or another analytical model of any suitable type, such as aforedescribed. Description of the non-limiting training sub-system 700 can be applicable to one or more other embodiments described herein, such as of FIGS. 3 and/or 4. Repetitive description of like elements and/or processes employed in respective embodiments is omitted for the sake of brevity.

That is, a training component 718 can receive training data 702, new data 706 and/or feedback 726, any one or more of which can be employed to train the machine learning model 720. This training can be conducted at any suitable frequency. New data 706 can comprise data relative to any one or more networks, clients, applications, devices, virtual machines, systems, components, hardware, software, and/or the like, such as which has not previously been observed by the ML model 720.

In one or more embodiments, the feedback 726 of one or more feedback loops can be employed to train the ML model 720. For example, an output 722 from the ML model can be fed back into the training component 718 to facilitate subsequent training of the ML model 720, and thus can enable the ML model 720 to self-improve its own accuracy, precision, prediction, patterns and/or other output. In one or more embodiments, the feedback 726 first can comprise storage of the output 722, and thus the feedback 726 can comprise historical data. In one or more cases, the historical data can comprise data from plural nodes of the object storage system.

In one or more additional and/or alternative embodiments, feedback 726 can be provided by one or more administrating entities 724. For example, output 722 from the ML model 720 can be reviewed for any one or more of accuracy, precision, correctness, applicability, and/or the like by a computer, machine, hardware, software, AI and/or human administrating entity 724. Via such quality check, subsequent outputs 722 of the ML model 720 can be improved. This review can be conducted at any suitable frequency. For example, a penalty can be added to a regularized model training loss function with some weight, such as by the training component 418, such as to influence/affect the training of the analytical model 420 by the training component 418.

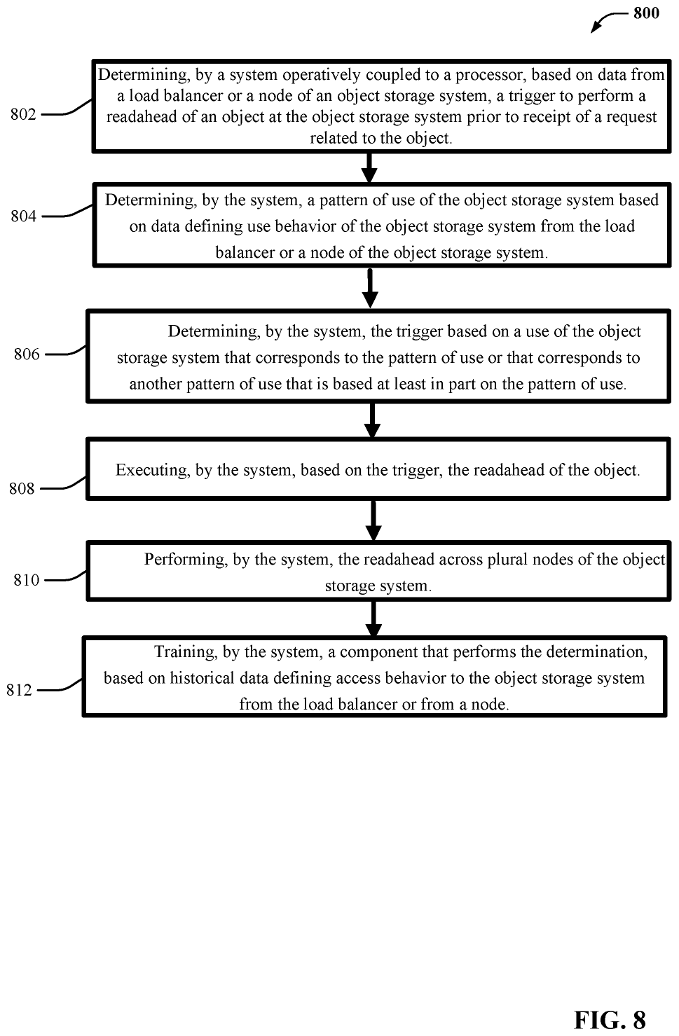

Next, FIG. 8 illustrates a flow diagram of an example, non-limiting method 800 that can facilitate a readahead process related to an object at an object storage system, in accordance with one or more embodiments described herein, such as the non-limiting 400 of FIG. 4. While the non-limiting method 800 is described relative to the non-limiting system 400 of FIG. 4, the non-limiting method 800 can be applicable also to other systems described herein, such as the non-limiting system 300 of FIG. 3. Repetitive description of like elements and/or processes employed in respective embodiments is omitted for the sake of brevity.

At 802, the non-limiting method 800 can comprise determining, by a system operatively coupled to the processor (e.g., detection component 414), based on data from a load balancer or a node of an object storage system, a trigger to perform a readahead of an object at the object storage system prior to receipt of a request related to the object.

At 804, the non-limiting method 800 can comprise determining, by the system (e.g., detection component 414) a pattern of use of the object storage system based on data defining use behavior of the object storage system from the load balancer or a node of the object storage system.

At 806, the non-limiting method 800 can comprise determining, by the system (e.g., detection component 414) a trigger based on a use of the object storage system that corresponds to the pattern of use or that corresponds to another pattern of use that is based at least in part on the pattern of use. That is, a pattern can change over time, and such changes can be detected, in one or more embodiments, via the detection component (e.g., detection component 414).

At 808, the non-limiting method 800 can comprise executing, by the system (e.g., readahead component 416), based on the trigger, the readahead of the object.

At 810, the non-limiting method 800 can comprise performing, by the system (e.g., readahead component 416), the readahead across plural nodes of the object storage system. For example, the readahead can be of plural objects distributed over plural nodes of the object storage system.

At 812, the non-limiting method 800 can comprise training, by the system (e.g., training component 418), a component (e.g., detection component 414 and/or analytical model 420) that performs the determination, based on historical data defining access behavior to the object storage system from the load balancer or from a node.

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. In addition, the computer-implemented and non-computer-implemented methodologies could alternatively be represented as a series of interrelated states via a state diagram or events. Additionally, the computer-implemented methodologies described hereinafter and throughout this specification are capable of being stored on an article of manufacture to facilitate transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

In summary, one or more systems, devices, computer program products, and/or computer-implemented methods of use provided herein to a readahead process related to an object at an object storage system. A system can comprise a memory that stores computer executable components, and a processor that executes the computer executable components stored in the memory, wherein the computer executable components can comprise a detection component that, based on data from a load balancer of an object storage system, determines a trigger to perform a readahead of an object at the object storage system prior to receipt of a request related to the object, and a readahead component that, based on the trigger, executes a readahead of the object. The detection component can determine a pattern of use of the object storage system. The detection component can comprise or access a machine learning model to perform the determination.

An advantage of the aforementioned systems, devices, computer program products, and/or computer-implemented methods can be an ability to reduce time and/or computing power involved with data reading and/or retrieval, such as relative to an object of an object storage system.

Another advantage of the aforementioned systems, devices, computer program products, and/or computer-implemented methods can be an ability to pre-empt one or more instructions, such as get and/or read instructions, which thus need not be sent.

Another advantage of the aforementioned systems, devices, computer program products, and/or computer-implemented methods can be an ability to learn and respond to new patterns and/or changes in patterns of use of an associated object storage system. This can be in relation to use of particular quantities or portions of data and/or in relation to one or more data groupings (e.g., objects) such as across plural nodes of an associated object storage system.

Indeed, in view of the one or more embodiments described herein, a practical application of the systems, computer-implemented methods, and/or computer program products described herein can be efficient and intuitive use of an analytical model to increase data recall, retrieval and/or read speed of an object storage system to a client, as compared to conventional object storage systems and/or control systems for object storage systems. Overall, such computerized tools can constitute a concrete and tangible technical improvement in the field of object storage systems and/or analytical modelling, predictive modeling, forecasting, AI, ML, DL, and/or active learning forecasting, without being limited thereto.

One or more embodiments described herein can be inherently and/or inextricably tied to computer technology and cannot be implemented outside of a computing environment. For example, one or more processes performed by one or more embodiments described herein can more efficiently, and even more feasibly, provide program and/or program instruction execution, such as relative to use of an object storage system, as compared to existing systems and/or techniques lacking such approach(es). Systems, computer-implemented methods, and/or computer program products facilitating performance of these processes are of great utility in the field of object storage systems and cannot be equally practicably implemented in a sensible way outside of a computing environment.

One or more embodiments described herein can employ hardware and/or software to solve problems that are highly technical, that are not abstract, and that cannot be performed as a set of mental acts by a human. For example, a human, or even thousands of humans, cannot efficiently, accurately and/or effectively generate, train, employ, and/or analyze digital use patterns, employing AI, as the one or more embodiments described herein can facilitate this process. And, neither can the human mind nor a human with pen and paper electronically effectively generate, train, employ, and/or analyze digital use patterns, employing AI, as conducted by one or more embodiments described herein.

In one or more embodiments, one or more of the processes described herein can be performed by one or more specialized computers (e.g., a specialized processing unit, a specialized classical computer, and/or another type of specialized computer) to execute defined tasks related to the one or more technologies describe above. One or more embodiments described herein and/or components thereof can be employed to solve new problems that arise through advancements in technologies mentioned above, cloud computing systems, computer architecture, and/or another technology.

One or more embodiments described herein can be fully operational towards performing one or more other functions (e.g., fully powered on, fully executed, and/or another function) while also performing one or more of the one or more operations described herein.

Turning next to FIGS. 9 and 10, a detailed description is provided of additional context for the one or more embodiments described herein at FIGS. 1-7.

FIG. 9 and the following discussion are intended to provide a brief, general description of a suitable operating environment 900 in which one or more embodiments described herein at FIGS. 1-7 can be implemented. For example, one or more components and/or other aspects of embodiments described herein can be implemented in or be associated with, such as accessible via, the operating environment 900. Further, while one or more embodiments have been described above in the general context of computer-executable instructions that can run on one or more computers, those skilled in the art will recognize that one or more embodiments also can be implemented in combination with other program modules and/or as a combination of hardware and software.

Generally, program modules include routines, programs, components, data structures, and/or the like, that perform particular tasks and/or implement particular abstract data types. Moreover, the aforedescribed methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based, and/or programmable consumer electronics, and/or the like, each of which can be operatively coupled to one or more associated devices.

Computing devices typically include a variety of media, which can include computer-readable storage media, machine-readable storage media and/or communications media, which two terms are used herein differently from one another as follows. Computer-readable storage media or machine-readable storage media can be any available storage media that can be accessed by the computer and includes both volatile and nonvolatile media, removable and non-removable media. By way of example, but not limitation, computer-readable storage media and/or machine-readable storage media can be implemented in connection with any method or technology for storage of information such as computer-readable and/or machine-readable instructions, program modules, structured data, and/or unstructured data.

Computer-readable storage media can include, but are not limited to, random access memory (RAM), read only memory (ROM), electrically erasable programmable read only memory (EEPROM), flash memory and/or other memory technology, compact disk read only memory (CD ROM), digital versatile disk (DVD), Blu-ray disc (BD) and/or other optical disk storage, magnetic cassettes, magnetic tape, magnetic disk storage and/or other magnetic storage devices, solid state drives or other solid state storage devices, and/or other tangible and/or non-transitory media which can be used to store specified information. In this regard, the terms “tangible” or “non-transitory” herein as applied to storage, memory and/or computer-readable media, are to be understood to exclude only propagating transitory signals per se as modifiers and do not relinquish rights to all standard storage, memory, and/or computer-readable media that are not only propagating transitory signals per se.

Computer-readable storage media can be accessed by one or more local or remote computing devices, e.g., via access requests, queries and/or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set and/or changed in such a manner as to encode information in one or more signals. By way of example, but not limitation, communication media can include wired media, such as a wired network, direct-wired connection, and/or wireless media such as acoustic, RF, infrared and/or other wireless media.

With reference still to FIG. 9, the example operating environment 900 for implementing one or more embodiments of the aspects described herein can include a computer 902, the computer 902 including a processing unit 906, a system memory 904 and/or a system bus 905. One or more aspects of the processing unit 906 can be applied to processors such as 306 and/or 406 of the non-limiting systems 300 and/or 400. The processing unit 906 can be implemented in combination with and/or alternatively to processors such as 306 and/or 406.

Memory 904 can store one or more computer and/or machine readable, writable and/or executable components and/or instructions that, when executed by processing unit 906 (e.g., a classical processor, and/or like processor), can facilitate performance of operations defined by the executable component(s) and/or instruction(s). For example, memory 904 can store computer and/or machine readable, writable and/or executable components and/or instructions that, when executed by processing unit 906, can facilitate execution of the one or more functions described herein relating to non-limiting system 300 and/or non-limiting system 400, as described herein with or without reference to the one or more figures of the one or more embodiments.

Memory 904 can comprise volatile memory (e.g., random access memory (RAM), static RAM (SRAM), dynamic RAM (DRAM) and/or the like) and/or non-volatile memory (e.g., read only memory (ROM), programmable ROM (PROM), electrically programmable ROM (EPROM), electrically erasable programmable ROM (EEPROM) and/or the like) that can employ one or more memory architectures.

Processing unit 906 can comprise one or more types of processors and/or electronic circuitry (e.g., a classical processor and/or like processor) that can implement one or more computer and/or machine readable, writable and/or executable components and/or instructions that can be stored at memory 904. For example, processing unit 906 can perform one or more operations that can be specified by computer and/or machine readable, writable and/or executable components and/or instructions including, but not limited to, logic, control, input/output (I/O), arithmetic and/or the like. In one or more embodiments, processing unit 906 can be any of one or more commercially available processors. In one or more embodiments, processing unit 906 can comprise one or more central processing unit, multi-core processor, microprocessor, dual microprocessors, microcontroller, System on a Chip (SOC), array processor, vector processor, and/or another type of processor. The examples of processing unit 906 can be employed to implement one or more embodiments described herein.

The system bus 905 can couple system components including, but not limited to, the system memory 904 to the processing unit 906. The system bus 905 can comprise one or more types of bus structure that can further interconnect to a memory bus (with or without a memory controller), a peripheral bus and/or a local bus using one or more of a variety of commercially available bus architectures. The system memory 904 can include ROM 910 and/or RAM 912. A basic input/output system (BIOS) can be stored in a non-volatile memory such as ROM, erasable programmable read only memory (EPROM) and/or EEPROM, which BIOS contains the basic routines that help to transfer information among elements within the computer 902, such as during startup. The RAM 912 can include a high-speed RAM, such as static RAM for caching data.

The computer 902 can include an internal hard disk drive (HDD) 914 (e.g., EIDE, SATA), one or more external storage devices 916 (e.g., a magnetic floppy disk drive (FDD), a memory stick or flash drive reader, a memory card reader, and/or the like) and/or a drive 920, e.g., such as a solid state drive or an optical disk drive, which can read or write from a disk 922, such as a CD-ROM disc, a DVD, a BD, and/or the like. Additionally, and/or alternatively, where a solid state drive is involved, disk 922 could not be included, unless separate. While the internal HDD 914 is illustrated as located within the computer 902, the internal HDD 914 can also be configured for external use in a suitable chassis (not shown). Additionally, while not shown in operating environment 900, a solid state drive (SSD) can be used in addition to, or in place of, an HDD 914. The HDD 914, external storage device(s) 916 and drive 920 can be connected to the system bus 905 by an HDD interface 924, an external storage interface 926 and a drive interface 928, respectively. The HDD interface 924 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 902, the drives and storage media accommodate the storage of any data in a suitable digital format. Although the description of computer-readable storage media above refers to respective types of storage devices, other types of storage media which are readable by a computer, whether presently existing or developed in the future, can also be used in the example operating environment, and/or that any such storage media can contain computer-executable instructions for performing the methods described herein.

A number of program modules can be stored in the drives and RAM 912, including an operating system 930, one or more applications 932, other program modules 934 and/or program data 936. All or portions of the operating system, applications, modules, and/or data can also be cached in the RAM 912. The systems and/or methods described herein can be implemented utilizing one or more commercially available operating systems and/or combinations of operating systems.

Computer 902 can optionally comprise emulation technologies. For example, a hypervisor (not shown) or other intermediary can emulate a hardware environment for operating system 930, and the emulated hardware can optionally be different from the hardware illustrated in FIG. 9. In a related embodiment, operating system 930 can comprise one virtual machine (VM) of multiple VMs hosted at computer 902. Furthermore, operating system 930 can provide runtime environments, such as the JAVA runtime environment or the .NET framework, for applications 932. Runtime environments are consistent execution environments that can allow applications 932 to run on any operating system that includes the runtime environment. Similarly, operating system 930 can support containers, and applications 932 can be in the form of containers, which are lightweight, standalone, executable packages of software that include, e.g., code, runtime, system tools, system libraries, and/or settings for an application.

Further, computer 902 can be enabled with a security module, such as a trusted processing module (TPM). For instance, with a TPM, boot components hash next in time boot components and wait for a match of results to secured values before loading a next boot component. This process can take place at any layer in the code execution stack of computer 902, e.g., applied at application execution level and/or at operating system (OS) kernel level, thereby enabling security at any level of code execution.

An entity can enter and/or transmit commands and/or information into the computer 902 through one or more wired/wireless input devices, e.g., a keyboard 938, a touch screen 940, and/or a pointing device, such as a mouse 942. Other input devices (not shown) can include a microphone, an infrared (IR) remote control, a radio frequency (RF) remote control and/or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint and/or iris scanner, and/or the like. These and other input devices can be connected to the processing unit 906 through an input device interface 944 that can be coupled to the system bus 905, but can be connected by other interfaces, such as a parallel port, an IEEE 1394 serial port, a game port, a USB port, an IR interface, a BLUETOOTH® interface and/or the like.

A monitor 946 or other type of display device can be alternatively and/or additionally connected to the system bus 905 via an interface, such as a video adapter 948. In addition to the monitor 946, a computer typically includes other peripheral output devices (not shown), such as speakers, printers and/or the like.

The computer 902 can operate in a networked environment using logical connections via wired and/or wireless communications to one or more remote computers, such as a remote computer(s) 950. The remote computer(s) 950 can be a workstation, a server computer, a router, a personal computer, portable computer, microprocessor-based entertainment appliance, a peer device and/or other common network node, and typically includes many or all of the elements described relative to the computer 902, although, for purposes of brevity, only a memory/storage device 952 is illustrated. Additionally, and/or alternatively, the computer 902 can be coupled (e.g., communicatively, electrically, operatively, optically, and/or the like) to one or more external systems, sources, and/or devices (e.g., computing devices, communication devices and/or like device) via a data cable (e.g., High-Definition Multimedia Interface (HDMI), recommended standard (RS) 232, Ethernet cable and/or the like).

In one or more embodiments, a network can comprise one or more wired and/or wireless networks, including, but not limited to, a cellular network, a wide area network (WAN) (e.g., the Internet), and/or a local area network (LAN). For example, one or more embodiments described herein can communicate with one or more external systems, sources, and/or devices, for instance, computing devices (and vice versa) using virtually any specified wired or wireless technology, including but not limited to: wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), high speed packet access (HSPA), Zigbee, and other 802.XX wireless technologies and/or legacy telecommunication technologies, BLUETOOTH®, Session Initiation Protocol (SIP), ZIGBEE®, RF4CE protocol, WirelessHART protocol, 6LoWPAN (IPv6 over Low power Wireless Area Networks), Z-Wave, an ANT, an ultra-wideband (UWB) standard protocol, and/or other proprietary and/or non-proprietary communication protocols. In a related example, one or more embodiments described herein can include hardware (e.g., a central processing unit (CPU), a transceiver, a decoder, and/or the like), software (e.g., a set of threads, a set of processes, software in execution, and/or the like) and/or a combination of hardware and/or software that facilitates communicating information among one or more embodiments described herein and external systems, sources, and/or devices (e.g., computing devices, communication devices and/or the like).

The logical connections depicted include wired/wireless connectivity to a local area network (LAN) 954 and/or larger networks, e.g., a wide area network (WAN) 956. LAN and WAN networking environments can be commonplace in offices and companies and can facilitate enterprise-wide computer networks, such as intranets, all of which can connect to a global communications network, e.g., the Internet.

When used in a LAN networking environment, the computer 902 can be connected to the local network 954 through a wired and/or wireless communication network interface or adapter 958. The adapter 958 can facilitate wired and/or wireless communication to the LAN 954, which can also include a wireless access point (AP) disposed thereon for communicating with the adapter 958 in a wireless mode.

When used in a WAN networking environment, the computer 902 can include a modem 960 and/or can be connected to a communications server on the WAN 956 via other means for establishing communications over the WAN 956, such as by way of the Internet. The modem 960, which can be internal and/or external and a wired and/or wireless device, can be connected to the system bus 905 via the input device interface 944. In a networked environment, program modules depicted relative to the computer 902 or portions thereof can be stored in the remote memory/storage device 952. The network connections shown are merely exemplary and one or more other means of establishing a communications link among the computers can be used.

When used in either a LAN or WAN networking environment, the computer 902 can access cloud storage systems or other network-based storage systems in addition to, and/or in place of, external storage devices 916 as described above, such as but not limited to, a network virtual machine providing one or more aspects of storage and/or processing of information. Generally, a connection between the computer 902 and a cloud storage system can be established over a LAN 954 or WAN 956 e.g., by the adapter 958 or modem 960, respectively. Upon connecting the computer 902 to an associated cloud storage system, the external storage interface 926 can, such as with the aid of the adapter 958 and/or modem 960, manage storage provided by the cloud storage system as it would other types of external storage. For instance, the external storage interface 926 can be configured to provide access to cloud storage sources as if those sources were physically connected to the computer 902.

The computer 902 can be operable to communicate with any wireless devices and/or entities operatively disposed in wireless communication, e.g., a printer, scanner, desktop and/or portable computer, portable data assistant, communications satellite, telephone and/or any piece of equipment or location associated with a wirelessly detectable tag (e.g., a kiosk, news stand, store shelf, and/or the like). This can include Wireless Fidelity (Wi-Fi) and BLUETOOTH® wireless technologies. Thus, the communication can be a predefined structure as with a conventional network or simply an ad hoc communication between at least two devices.

The illustrated embodiments described herein can be employed relative to distributed computing environments (e.g., cloud computing environments), such as described below with respect to FIG. 10, where certain tasks are performed by remote processing devices that are linked through a communications network. In a distributed computing environment, program modules can be located both in local and/or remote memory storage devices.

For example, one or more embodiments described herein and/or one or more components thereof can employ one or more computing resources of the cloud computing environment 1002 described below with reference to illustration 1000 of FIG. 10. For instance, one or more embodiments described herein and/or components thereof can employ such one or more resources to execute one or more: mathematical function, calculation and/or equation, computing and/or processing script, algorithm, model (e.g., artificial intelligence (AI) model, machine learning (ML) model, deep learning (DL) model, and/or like model), and/or other operation in accordance with one or more embodiments described herein.

It is to be understood that although one or more embodiments described herein include a detailed description on cloud computing, implementation of the teachings recited herein are not limited to a cloud computing environment. Rather, one or more embodiments described herein are capable of being implemented in conjunction with any other type of computing environment now known or later developed. That is, the one or more embodiments described herein can be implemented in a local environment only, and/or a non-cloud-integrated distributed environment, for example.

A cloud computing environment can provide one or more of low coupling, modularity and/or semantic interoperability. At the heart of cloud computing is an infrastructure that includes a network of interconnected aspects.

Moreover, the non-limiting systems 100, 200, 300, and/or 400, and/or the example operating environment 900 of FIG. 9, can be associated with and/or be included in cloud-based and/or partially-cloud-based system.

Referring now to details of one or more elements illustrated at FIG. 10, the illustrative cloud computing environment 1002 is depicted. Cloud computing environment 1002 can comprise one or more cloud computing nodes, virtual machines and/or the like with which local computing devices used by cloud clients 1004, such as for example via one or more devices 1006, systems 1008, virtual machines 1010, networks 1012, and/or applications 1014.

The one or more cloud computing nodes, virtual machines and/or the like can be grouped physically or virtually, in one or more networks, such as local, distributed, private, public clouds, and/or a combination thereof. The cloud computing environment 1002 can provide infrastructure, platforms, virtual machines, and/or software for which a client 1004 does not maintain all or at least a portion of resources on a local device, such as a computing device. The various elements 1006 to 1012 are not intended to be limiting and are but some of various examples of computerized elements that can communicate with one another and/or with the one or more cloud computing nodes via the cloud computing environment 1002, such as over any suitable network connection and/or type.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device, and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and/or any suitable combination of the foregoing. A computer readable storage medium, as used herein, is not to be construed as being transitory signals per se, such as radio waves and/or other freely propagating electromagnetic waves, electromagnetic waves propagating through a waveguide, and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer, and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer, and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus, and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment, and/or portion of instructions, which comprises one or more executable instructions for implementing the specified logical function(s). In one or more alternative implementations, the functions noted in the blocks can occur out of the order noted in the figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented in combination with one or more other program modules. Generally, program modules include routines, programs, components, data structures, and/or the like that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), microprocessor-based or programmable consumer and/or industrial electronics, and/or the like. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform,” “interface,” and/or the like, can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, and/or nonvolatile random access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the one or more embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer executable components; and
a processor that executes the computer executable components stored in the memory, wherein the computer executable components comprise:
a detection component that, based on data from a load balancer of an object storage system, determines a trigger to perform a readahead of an object at the object storage system prior to receipt of a request related to the object; and
a readahead component that, based on the trigger, executes the readahead of the object.

2. The system of claim 1, wherein the detection component further determines a pattern of use of the object storage system based on data defining use behavior of the object storage system from the load balancer.

3. The system of claim 2, wherein the detection component further determines the trigger based on a use of the object storage system that corresponds to the pattern of use or that corresponds to another pattern of use that is based at least in part on the pattern of use.

4. The system of claim 1, wherein the detection component comprises or accesses a machine learning model to perform the determination.

5. The system of claim 1, further comprising:
a training component that trains the detection component based on historical data defining access behavior to the object storage system from the load balancer, and wherein the historical data comprises data from plural nodes of the object storage system.

6. The system of claim 1, wherein the readahead is of a quantity of data of the object at the object storage system or of plural objects, comprising the object, at the object storage system.

7. The system of claim 1, wherein the readahead component performs the readahead across plural nodes of the object storage system.

8. The system of claim 1, wherein the object storage system is configured to move the object over plural nodes of the object storage system over a life of the object at the object storage system.

9. The system of claim 1, wherein the trigger is based on a request to the object storage system that comprises a request for access to or information of the object.

10. A computer-implemented method, comprising:
determining, by a system operatively coupled to a processor, based on data from a load balancer of an object storage system, a trigger to perform a readahead of an object at the object storage system prior to receipt of a request related to the object; and
executing, by the system, based on the trigger, the readahead of the object.

11. The computer-implemented method of claim 10, further comprising:
determining, by the system, a pattern of use of the object storage system based on data defining use behavior of the object storage system from the load balancer.

12. The computer-implemented method of claim 11, further comprising:
determining, by the system, the trigger based on a use of the object storage system that corresponds to the pattern of use or that corresponds to another pattern of use that is based at least in part on the pattern of use.

13. The computer-implemented method of claim 10, further comprising:
employing or accessing a machine learning model to perform the determination.

14. The computer-implemented method of claim 10, further comprising:
training, by the system, a component that performs the determination, based on historical data defining access behavior to the object storage system from the load balancer, and wherein the historical data comprises data from plural nodes of the object storage system.

15. The computer-implemented method of claim 10,
wherein the readahead is of a quantity of data of the object at the object storage system or of plural objects, comprising the object, at the object storage system, and
wherein the readahead component performs the readahead across plural nodes of the object storage system.

16. A computer program product facilitating a readahead process related to an object at an object storage system, the computer program product comprising a computer readable storage medium having program instructions embodied therewith, the program instructions executable by a processor to cause the processor to:
determine, by the processor, based on data from a load balancer of an object storage system, determines a trigger to perform a readahead of an object at the object storage system prior to receipt of a request related to the object; and
execute, by the processor, based on the trigger, the readahead of the object.

17. The computer program product of claim 16, wherein the program instructions are further executable by the processor to cause the processor to:
determine, by the processor, a pattern of use of the object storage system based on data defining use behavior of the object storage system from the load balancer.

18. The computer program product of claim 17, wherein the program instructions are further executable by the processor to cause the processor to:
determine, by the processor, the trigger based on a use of the object storage system that corresponds to the pattern of use or that corresponds to another pattern of use that is based at least in part on the pattern of use.

19. The computer program product of claim 16, wherein the program instructions are further executable by the processor to cause the processor to:
employ or access, by the processor, a machine learning model to perform the determination.

20. The computer program product of claim 16, wherein the program instructions are further executable by the processor to cause the processor to:
train, by the processor, a component that performs the determination, based on historical data defining access behavior to the object storage system from the load balancer, and wherein the historical data comprises data from plural nodes of the object storage system.
